(19) United States
(12) Patent Application Publication
(10) Pub. No.: US 2014/0258304 A1
(43) Pub. Date: Sep. 11, 2014

(54) ADAPTABLE FRAMEWORK FOR ONTOLOGY-BASED INFORMATION EXTRACTION

(71) Applicant: GM GLOBAL TECHNOLOGY OPERATIONS LLC, Detroit, MI (US)

(72) Inventors: Gregory D. Sabanski, Oakland Township, MI (US); Martin Case, Warren, MI (US); Soumen De, Bangalore (IN); Dnyanesh Rajpathak, Bangalore (IN)

(73) Assignee: GM GLOBAL TECHNOLOGY OPERATIONS LLC, DETROIT, MI (US)

(21) Appl. No.: 13/792,913

(22) Filed: Mar. 11, 2013

(51) Int. Cl. G06F 17/30

(52) U.S. Cl. CPC G06F 17/3071
USPC 707/740

(57) ABSTRACT

A warranty database stores service repair verbatims. An ontology database that specifies relationships between service terms includes linking relationships between vehicle terminology and cluster categories. The ontology database is reconfigurable for allowing a user to add, delete, and modify contents within the ontology database. A verbatim extraction tool extracts service repair verbatims from the warranty database as function of user selected parameters and a user selected ontology. The user selected ontology is a subset of the ontology database. The service verbatims are segregated into a plurality of cluster categories as a function of the selected parameters and the user selected ontology. A report generating device selectively generated reports based on segregating service verbatims into a plurality of cluster categories. Each respective cluster category includes associated service repair verbatims that are selected as a function of the linking relationship of terms within the service verbatim and the user selected ontology.

### BACKGROUND OF INVENTION

An embodiment relates generally to extracting information from service verbatims.

Typical text mining tools generate searches utilizing simple search criteria such as single term searches. Many current text mining tools utilize predetermined search filters, predetermined terminology, and predetermined diagnostic and prognostic ontology. Users of the system are typically left at the peril of utilizing general search parameters and extraction tools as generated by a third party. Due to the predetermined filters and search engines, searches may not only be time consuming in having to sift through the various amounts of unrelated data, but the search criteria may not be as precise as a user would like. For example, an ontology database is typically created and maintained for a respective service engineering group. As a result, a user may be constrained to utilizing the relationships as set forth by the ontology database as created by the respective service engineering group. Any changes to the search fields or ontology database must be approved and modified by this respective service engineering group. Moreover, when extracting data from the database, the ontology database may contain all systems, subsystems, components, etc., of a vehicle, when in reality, the user is focused only on a specific subset of the ontology database. As a result, execution times for extracting the service data are greatly decreased.

### SUMMARY OF INVENTION

An advantage of the embodiment described herein is user defined ontology used to mine service verbatims from a centralized database. The user defined ontology is reconfigurable such that the user maintains a local copy of the primary ontology in which the user can customize the local ontology by adding, deleting, and modifying terms in the local ontology. As a result, the user can customize the ontology for a specific technology, system, subsystem, component, symptom, or failure mode. Therefore, when the ontology is utilized to query the search, the file size of the ontology is reduced and the processing time for executing the query is minimized. As a result, the user is not confined by generic ontologies, but rather, can maintain a plurality of ontologies that are customized to a respective focus area of the vehicle.

An embodiment contemplates a method of categorizing service verbatims in a vehicle service reporting system. Service repair verbatims are stored in a warranty storage database that includes at least one memory storage device. The service repair verbatims include information relating to an identified concern with the vehicle. An ontology database is generated that specifies relationships between service terms that include linking relationships between vehicle terminology and cluster categories. The ontology database is reconfigurable for allowing a user to add, delete, and modify contents within the ontology database. Service repair verbatims are extracted from the warranty database as function of user selected parameters and a user selected ontology utilizing a verbatim extraction tool. The user selected ontology is a subset of the ontology database. The service verbatims are segregated into a plurality of cluster categories as a function of the selected parameters and the user selected ontology. Reports are selectively generated based on segregating service verbatims into a plurality of cluster categories using a report generating device. The reports identify an aggregate number of service verbatims associated with respective cluster categories. Each respective cluster category includes associated service repair verbatims that are selected as a function of the linking relationship of terms within the service verbatim and the user selected ontology

An embodiment contemplates a warranty detection system for service repairs of vehicles. A warranty database stores service repair verbatims. The service repair verbatims include information relating to an identified concern with the vehicle. An ontology database that specifies relationships between service terms includes linking relationships between vehicle terminology and cluster categories. The ontology database is reconfigurable for allowing a user to add, delete, and modify contents within the ontology database. A verbatim extraction tool extracts service repair verbatims from the warranty database as function of user selected parameters and a user selected ontology. The user selected ontology is a subset of the ontology database. The service verbatims are segregated into a plurality of cluster categories as a function of the selected parameters and the user selected ontology. A report generating device selectively generated reports based on segregating service verbatims into a plurality of cluster categories. The reports identify an aggregate number of service verbatims associated with respective cluster categories. Each respective cluster category includes associated service repair verbatims that are selected as a function of the linking relationship of terms within the service verbatim and the user selected ontology.

### BRIEF DESCRIPTION OF DRAWINGS

FIG. 1 is a block diagram of an overview of a reconfigurable framework for an ontology based information extraction system.

FIG. 2 illustrates an exemplary menu table for selecting a vehicle relating to a model year for executing a query.

FIG. 3 illustrates an exemplary menu table for selecting a build region for executing the query.

FIG. 4 illustrates an exemplary menu table for selecting a sales region for executing the query.

FIG. 5 illustrates an exemplary menu table for selecting a sales country for executing the query.

FIG. 6 illustrates an exemplary menu table for selecting a vehicle system or vehicle component for executing the query.

FIG. 7 illustrates an exemplary menu table for selecting a bill of material for executing the query.

FIG. 8 illustrates an exemplary menu table for selecting a labor code for executing the query.

FIGS. 9-10 illustrate exemplary menu tables for selecting an ontology.

FIG. 11 is an example of an exemplary selected ontology.

FIG. 12 is an exemplary option menu for identifying the type of verbatim data to be selected.

FIG. 13 illustrates an exemplary selection approach menu for searching the verbatim.

FIG. 14 illustrates an output for a labor code and verbatim analysis.

FIG. 15 illustrates a table listing of service verbatims categorized as a function of the selected ontology.

FIG. 16 illustrates an exemplary listing of service verbatims for a respective category.

FIG. 16b illustrates exemplary details of the comments field of the service verbatim.

FIG. 17 illustrates exemplary service verbatims binned to a no-match category.

FIGS. 18-19 illustrate menu tables for selectively re-categorizing service verbatims from the no-match category to an existing or new category.

FIG. 20 illustrates an output table identifying the newly entered terms.

FIG. 21 illustrates a system block diagram for extracting service verbatims.

FIG. 22 illustrates a flow diagram of an ontology wizard.

FIG. 23 illustrates a block diagram of the ontology wizard for selecting, pruning, and merging ontologies.

### DETAILED DESCRIPTION

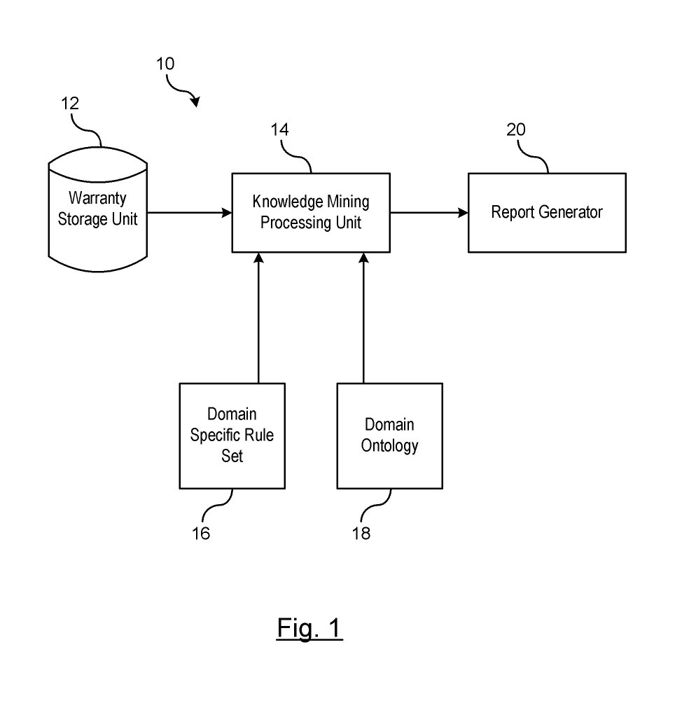

FIG. 1 shows a block diagram of an overview of a reconfigurable framework for an ontology based information extraction system 10. In the extraction system 10, an ontology provides a system framework for identifying whether respective categories have relations to one another. The concept is to formalize the service domain specific knowledge by defining the classes, subclasses and identifying their relationships to one another. Respective categories of concepts used in service ontology include, but are not limited to, Part, Action, Symptom, PartLocation, and LaborCode.

The extraction system 10, includes a warranty database 12 for storing service repair verbatims provided by one or more service or repair facilities, a knowledge mining processing unit 14 for extracting service verbatims from the warranty database 12, a domain specific rule set 16, a domain ontology database 18, and a report generator 20 for generating failure counts of selected key terms.

The warranty database 12 includes a memory storage unit which stores information relating a concern with a repair of the vehicle. The warranty database 12 preferably is a central memory storage unit that receives and compiles service repair verbatims from all the vehicle service facilities. However, it should be understood that more than one memory storage unit can be used, each of which are cooperatively used to store and supply data.

Vehicle service facilities submit service verbatims and other service information to the warranty database 12 upon analyzing the problem, determining the cause of the problem, performing a repair action, or upon reporting no trouble found (NTF).

Labor codes are used to identify a repair made to the vehicle when servicing the vehicle. After a repair has been attempted, the labor code is submitted along with the service repair verbatim. The labor code includes a predefined description (e.g., numeric or alphanumeric) of the repair made to the vehicle. Since the labor code has a predefined description, it does not typically have available any space to allow any other specifics to be entered in its field such as the concern reported (e.g., complaint) or cause of the concern. Service personnel are required to input cause, concern, and repair comments as part of the service repair verbatim. The service personnel may include comments from the service technicians performing work on the vehicle that have direct knowledge of the repair and reasons for the failed part. The service personnel may also include service managers that discuss the concern/complaints with the customer. The service managers may add customer comments relating to the reason the vehicle is being serviced. The information (e.g., commentary) provided by the service personnel that includes a description of the failed part, the concern/complaint by the owner of the vehicle, the cause of the failed part as determined by the service technician, and the corrected repair made to the vehicle by the service technician is referred to as a service repair verbatim and is provided to the warranty database 12.

The knowledge mining processing unit 14 extracts claims from the warranty database 12 using the domain specific rule set 16 and the ontology from the domain ontology database 18. The domain specific rule set 16 is a user selected rule set that configures rules for extracting particular domain specific details relating to the vehicle from the warranty database 12. The rules may be configured parameters entered by the user. Such parameters may include, but are not limited to, type of vehicle, model year, region of sale, manufacturing plant, and service location. The user selected rules may further include special case parameters wherein the user is allowed to generate its own specific rules as opposed to selecting from a domain.

The domain ontology database 18 provides a system framework for identifying relationships of parts, systems, subsystems, terminology, and functionality phrases that have working relationships to one another. Initially, a primary ontology database is provided that is generated by a centralized group of the organization. Thereafter, a local ontology database, herein referred to as the ontology database, is downloaded from the primary database. The ontology database 18 may be stored on a local computer or server, which allows the user to modify and save its working version of the database without affecting the primary ontology database file. The ontology database 18, once stored locally may be modified by adding, deleting, or revising contents therein. The user may overwrite the locally saved version, or may rename the filename to maintain different versions of the ontology. As a result, for a user that works primarily with a respective focus area (e.g., subsystem, component), the user can modify the ontology database thereby creating a subset of the ontology database from the primary ontology database file to reflect only contents associated with the respective focus area. As a result, the ontology will be smaller resulting in shorter execution times.

The knowledge mining processing unit 14 is an analytical tool that extracts service repair verbatims from the warranty database as a function of the user selected parameters and a user selected ontology. The user selected ontology is a subset of the ontology database where the service verbatims are segregated into a plurality of cluster categories. The knowledge mining processing unit 14 searches the text of the verbatim, extracts key terms from the verbatim, and categorizes the key terms so that reports may be generated based on data other than just labor codes.

The report generator 20 generates charts or graphs for identifying an aggregate number of service repair verbatims based on the key terms selected by the user. The user as discussed herein is any person who uses the reports to identify trends and determine emerging warranty issues. The user may select a part and at least one of the key terms for generating a report. The report will typically include a time trend of the reported concern, cause, correction or combination thereof.

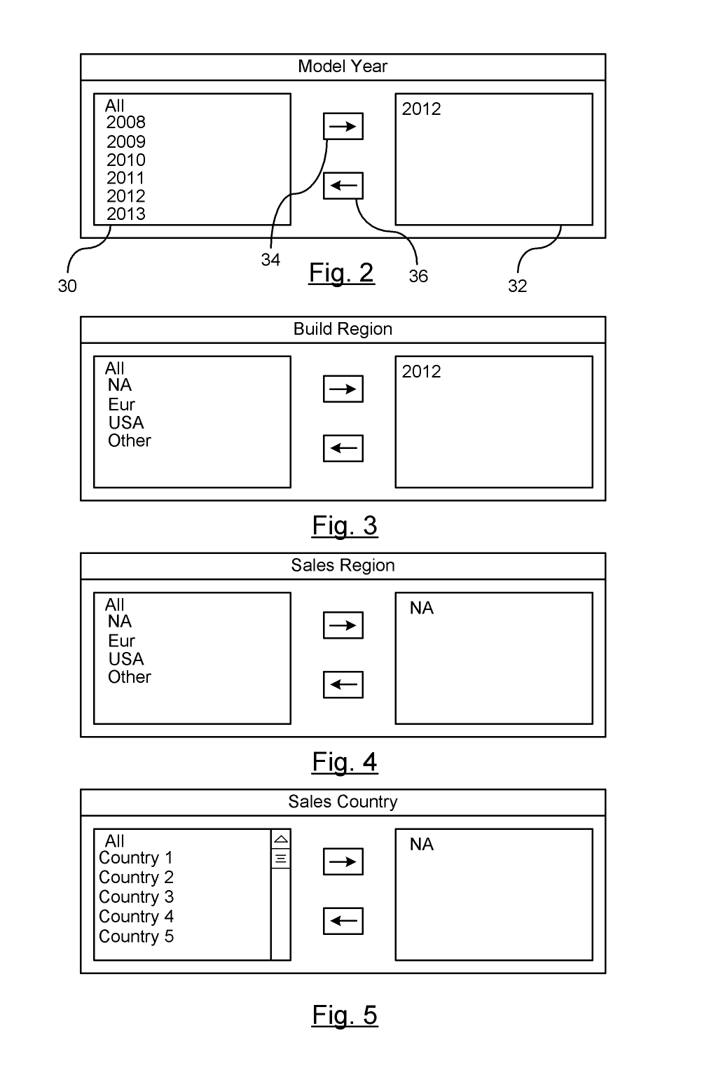

FIGS. 2-9 illustrate menu tables that contain vehicle-related criteria that are used to query and extract service associated verbatims from the warranty database. Various parameters may be selected which allows the user to focus on respective characteristics of a vehicle, manufacturing facility, and/or vehicle system.

FIG. 2 is a menu table for selecting a vehicle relating to a model year. More than one model year can be selected. As shown in FIG. 2, menu 30 provides the available model years that can be selected as filter criteria. Selected search criteria 32 identifies those respective model years that are selected for extracting service verbatims from the warranty database. Add button 34 and a remove button 36 allow a user to add one or more vehicle model years and remove one or more vehicle model years, respectively, from the selected search criteria 32. The filter criteria in the selected search criteria 32 are used to identify those respective service verbatims associated with the respective criteria.

FIGS. 3-9 illustrate menu tables illustrating different criteria for searches. Each of the tables will have the same tools for adding and removing filter criteria, and therefore, will not be described in detail further. FIG. 3 illustrates criteria that can be used to filter a build region of the vehicle. This identifies a region where the vehicle was built. Such regions may include, but are not limited to, North America, Europe, USA, South America. Selected regions are then added to the selected search criteria box.

FIG. 4 illustrates criteria that can be used to filter a sales region of the vehicle. This identifies a region where the vehicle is sold. Such regions may be similar to those include, but are not limited to, North America, Europe, South America. Selected regions are then added to the selected search criteria box.

FIG. 5 illustrates criteria that can be used to further define the sales region by identifying respective countries in which the vehicles are built.

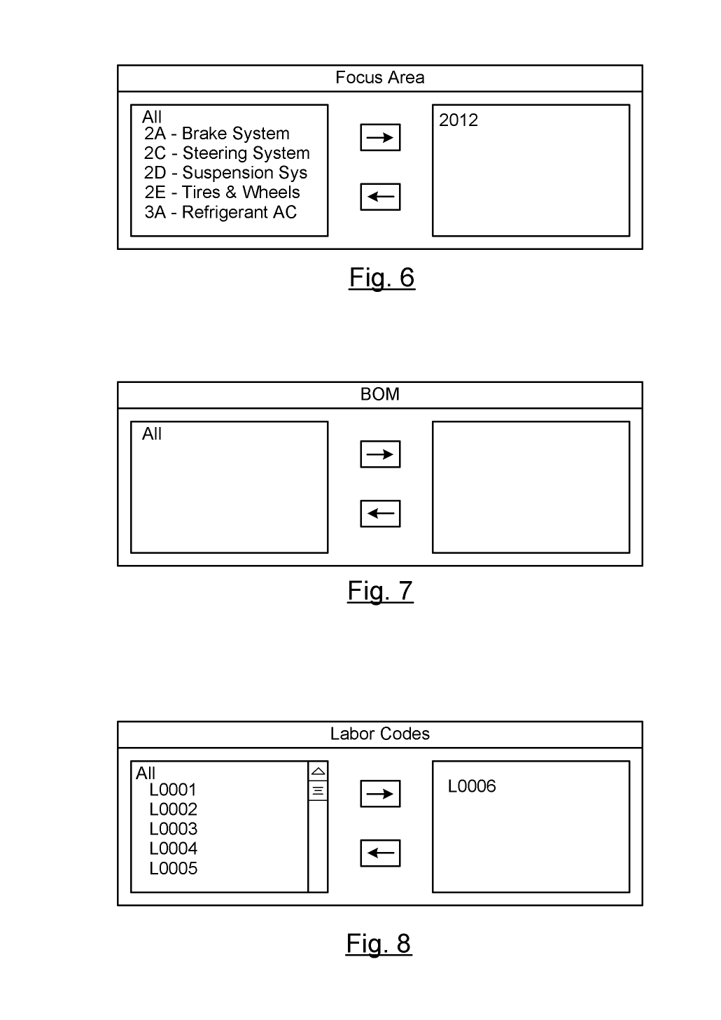

FIG. 6 illustrates criteria that focus on a system or component of the vehicle. The criteria may include a part, subsystem, or system of the vehicle. Examples of systems include, but are note limited to, brake systems, steering systems, suspension systems, climate systems, and electronic systems.

FIG. 7 illustrates a bill of material for a vehicle. This may include all or a portion of the bill of material for a vehicle. The bill of material is a list of the raw materials, sub-assemblies, sub-components, parts and the quantities that are needed to manufacture the vehicle.

FIG. 8 illustrates labor codes that can be used to further define the service verbatim query by focusing on respective repairs made to the vehicle.

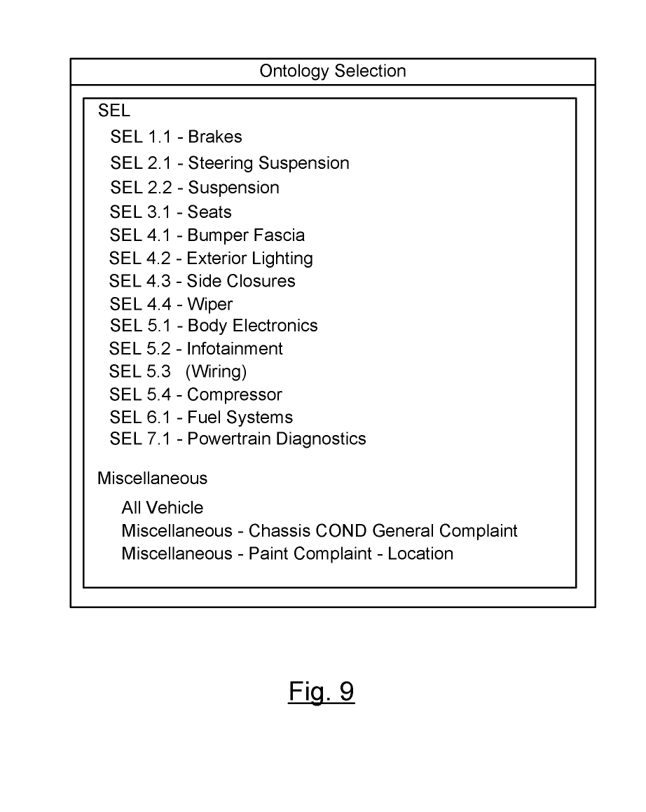

FIG. 9 illustrates an ontology selection menu that provides a plurality of selectable ontologies. The selected ontology is used in cooperation with the user selected parameters for selecting service verbatims from the service warranty database. The user may select from a respective system, for example, brakes, seats, fuel system, or a miscellaneous ontology may be selected. A miscellaneous ontology may include general complaints related to a respective technology. Such examples may include, but are not limited to, chassis general complaints, electrical general complaints, and paint general complaints.

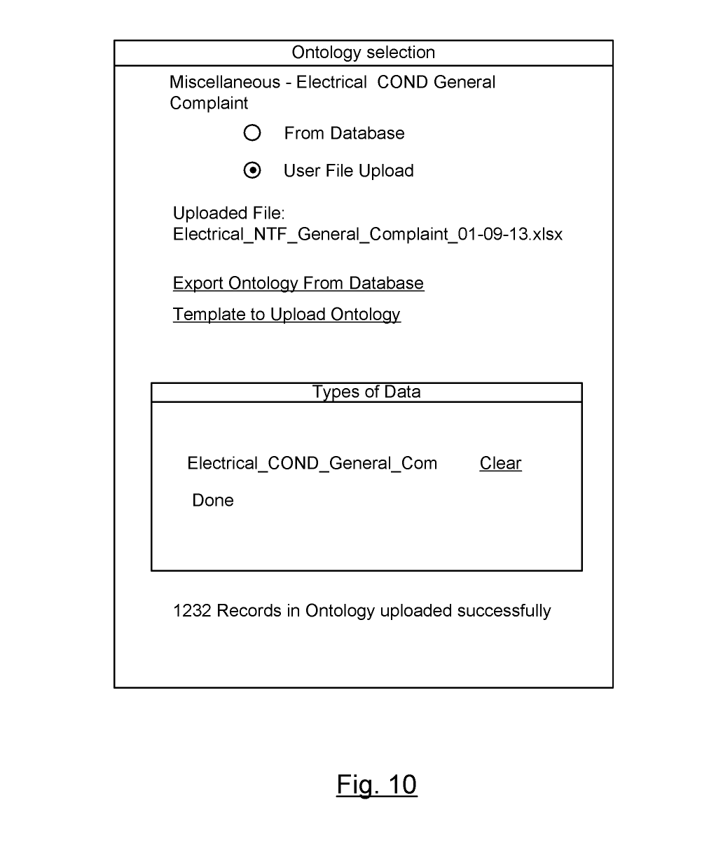

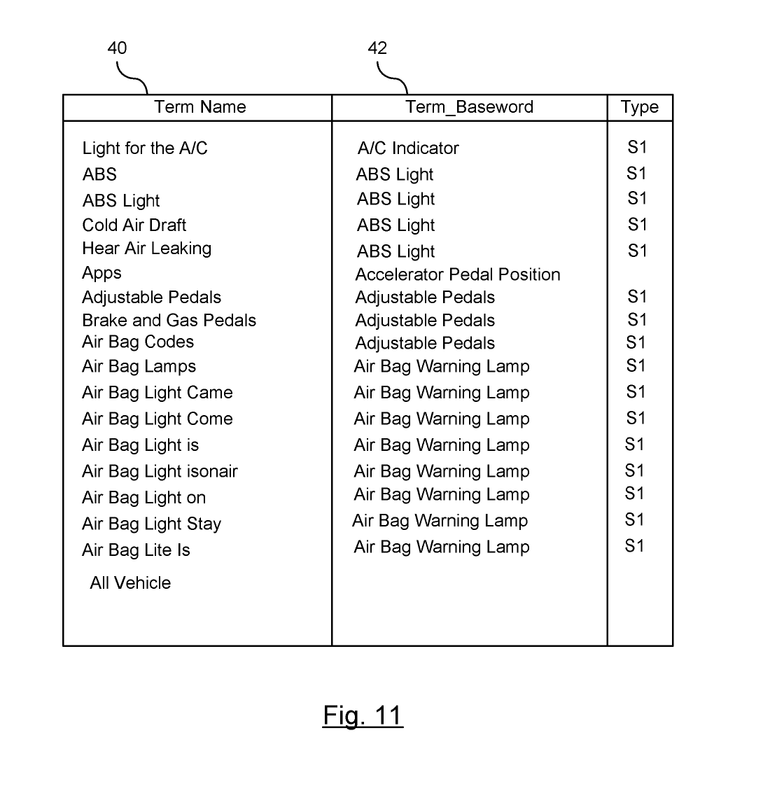

FIG. 10 illustrates an ontology selection query menu. The user selects an ontology, such as the Electrical General Complaints, and then selects whether this ontology should be downloaded from the primary ontology database or a local ontology database (i.e., located on the local server or local computer of the user). The local ontology database is a user version of the Electrical General Complaints ontology that has been modified and updated by the user. This ontology database is modified (e.g., additions, deletions, revisions) so that it is tailored to the user's expectations. By utilizing the local ontology database, processing times are shorter and the queries are more focused to the user desired ontology.

FIG. 11 illustrates an exemplary ontology for the Electrical General Complaints ontology. It should be understood that the ontology as shown is only a snapshot of a portion of the ontology, and that the example as shown is not inclusive of the entire ontology database. The ontology includes a term name 40 that is typically one or more terms that make up a phrase in a verbatim. The term name may be entered by selecting the term in a verbatim phrase and copied over, or may be entered directly by the user. The ontology further includes basewords 42. The basewords 42 represent a category name that a term name 40 is associated with. As a result, each baseword 42 may be linked to more than one term name 40.

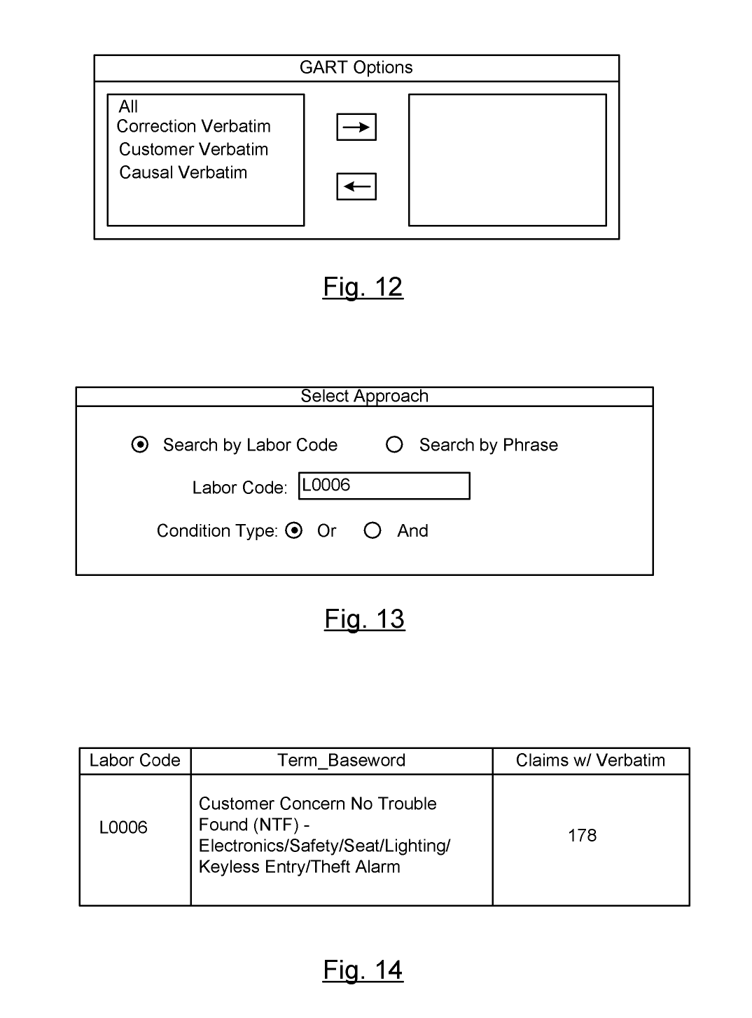

FIG. 12 illustrates a selection tool that identifies the type of verbatim data that may be selected by the user if more that one type of verbatim is entered into the service warranty database. For example, different types of verbatim data include, but are not limited to, correction verbatims, customer verbatims, and causal verbatims.

FIG. 13 illustrates a selection approach menu for searching the verbatim. The search may be based on the Labor Code or a Phrase. For example, if a search is executed using the labor code, mining is performed on a list of verbatim records that are associated with the labor code.

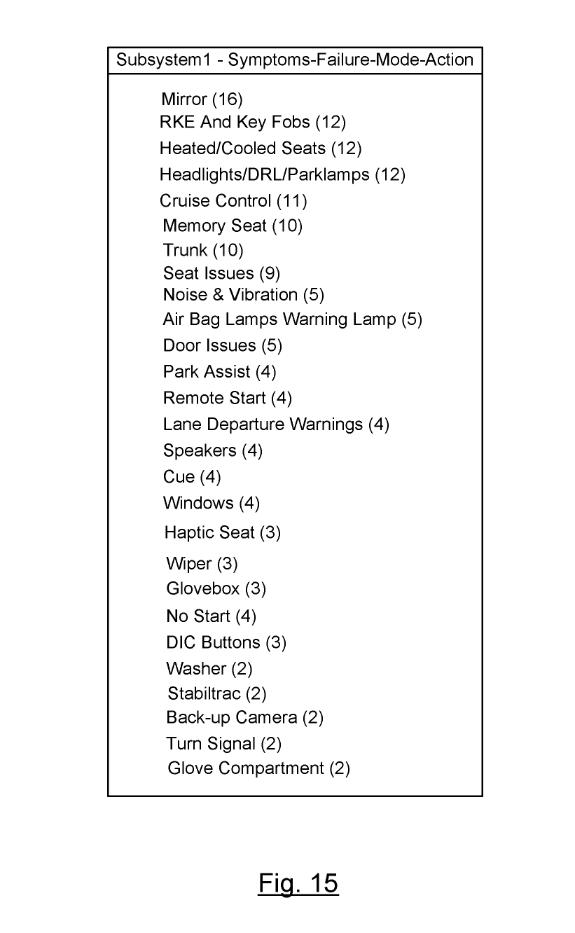

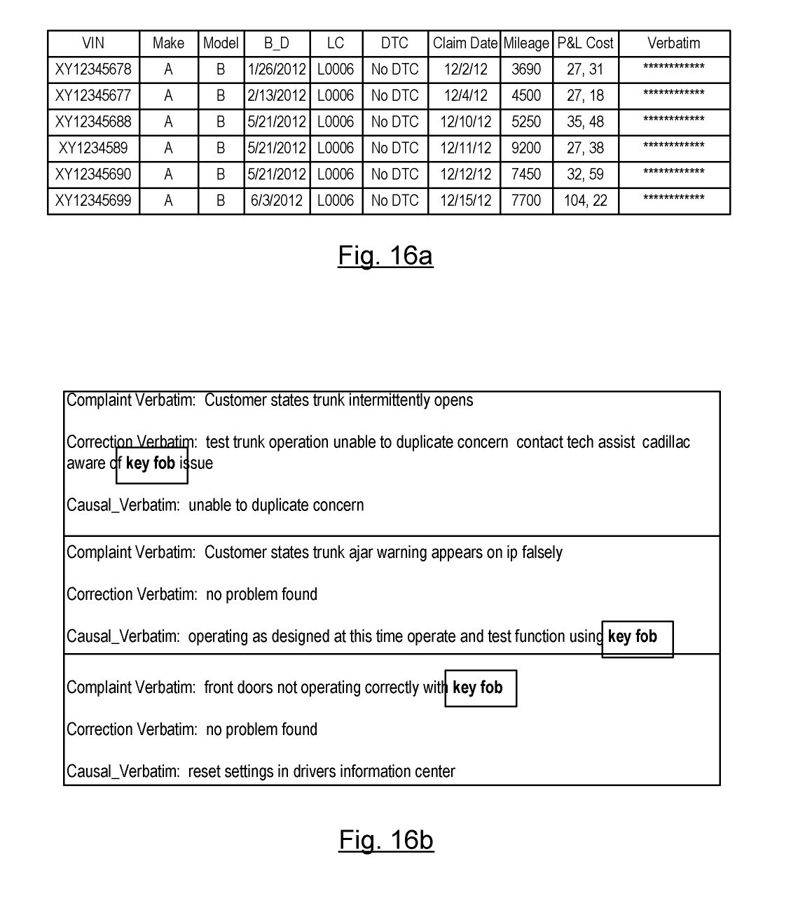

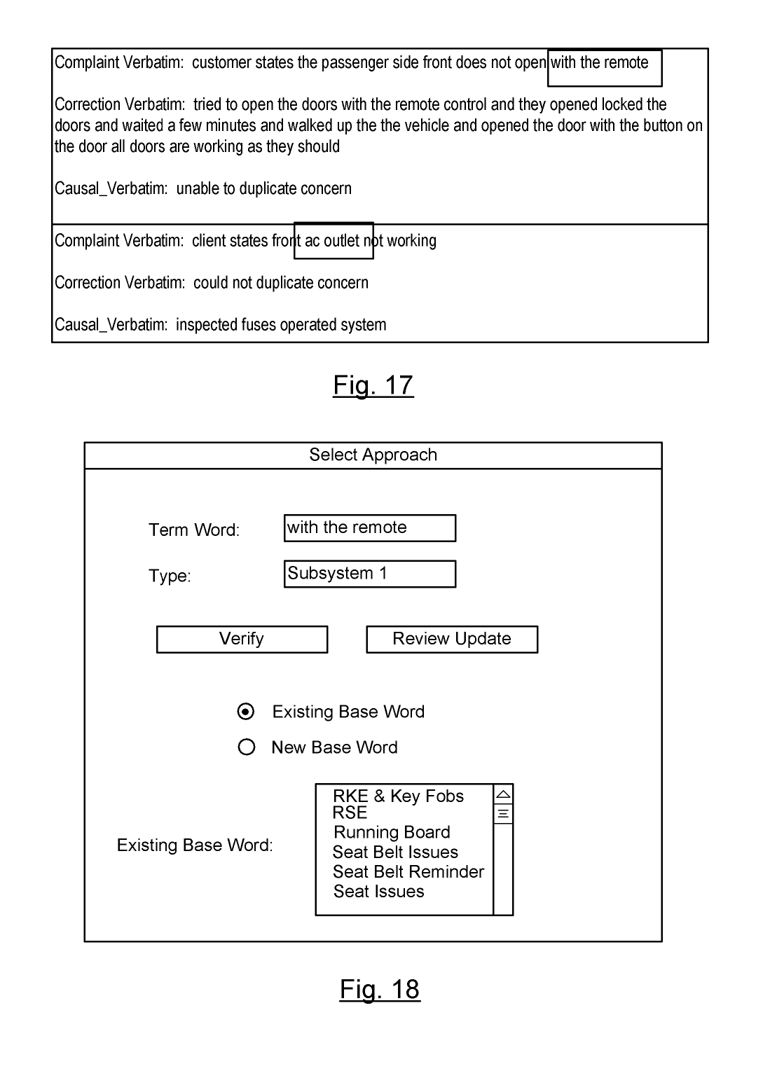

FIG. 14 illustrates the labor code and verbatim analysis identifying the number of records that are mined as a function of the query. The mined service verbatims are binned to their respective categories based on the selected ontology as shown in FIG. 15. Each of the categories is basically buckets that include the respective verbatims that are associated with the category based on the selected ontology. A processing device will search each of the terms within the service verbatims and will assign a verbatim to a respective category if a phrase within the verbatim matches a term name associated with a baseword. As a result, the respective claims as mined using the selected parameters are binned to their respective categories based on the user customized ontology. The user may select a respective category and review detailed information relating to the vehicle and the verbatim associated with the repair for that respective category. FIG. 17 illustrates a sample of a selected category and exemplary verbatims within the selected category. As illustrated in FIG. 16, the labor code, labor code description, and the associated claims associated with the verbatim are identified. FIG. 16b shows the description that would be shown in the verbatim field.

In the event, service verbatims are present that match the user selected parameters, but do not match the ontology, then the non-matching service verbatims are binned to a no-match category. The no-match category provides the user with various advantages. First, the no-match category alerts the user to new types of issues; second, it provides a representation to the user as to what is not matching the ontology.

The user, in response to having service verbatim claims binned in the no-match category, may then open the no-match category and review each of the service verbatim claims therein. The user may review the terminology in the verbatim and may identify key terms or phrases that should be associated with an existing baseword but has not been entered. As a result, the user may select and copy the phrase or manually enter the phrase to the ontology database as a term name and link it to an associated baseword. Alternatively, the user may create a new baseword category and link the respective term or phrase to the new baseword category. As a result, for service verbatims that are early on identified as a no-match or miscellaneous, the reconfigurable ontology allows the user to modify its contents so that service verbatims may be properly binned. After re-executing the mining operation with the revised ontology, one or more service verbatims will be removed from the no-match category and re-binned to a respective category. This technique provides a means to scale down the number of verbatims in the no-match category and update the user specific ontology with new terms.

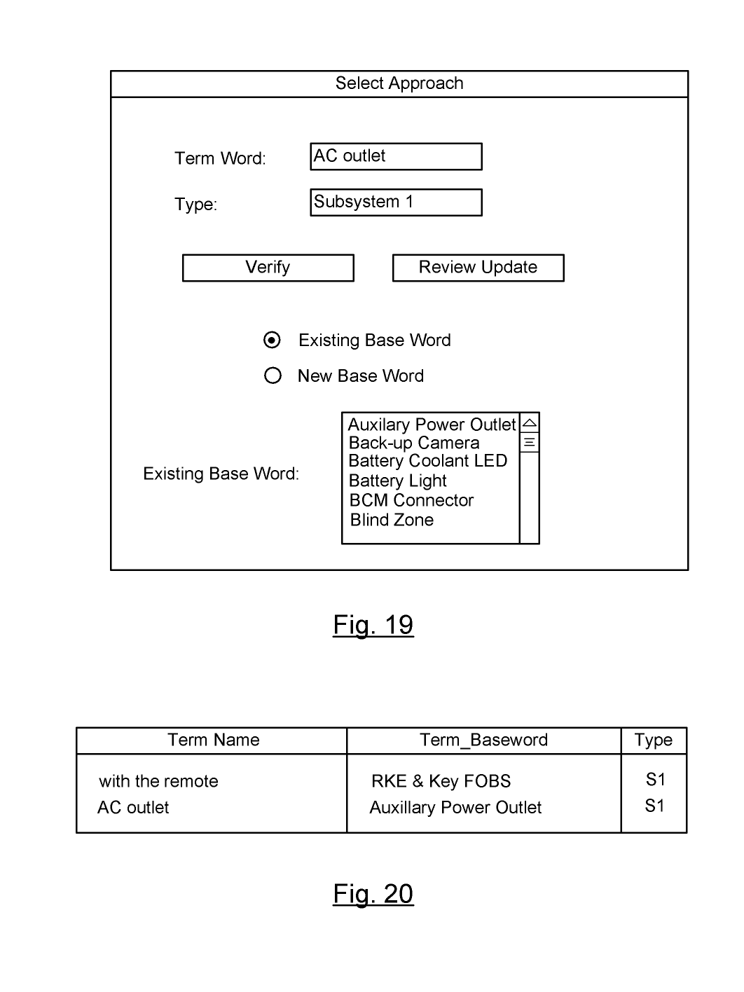

FIGS. 17-19 show tables illustrating how an ontology is updated. FIG. 19 shows two respective service verbatim claims binned to the no-match category. The service verbatims are analyzed by the user and key terms/phrases are identified in the service verbatims (e.g., AC outlet and with the remote). These terms are highlighted and added to the ontology (e.g., ontology wizard). The selected terms/phrases are entered in the space allocated for the term-word as illustrated in FIGS. 19 and 20. A type may be entered that relates to whether the selected term is a subsystem or symptom. If a symptom is entered, then the symptom has to be associated with a subsystem.

The user then designates whether the entered term name is associated with an existing base term or a new base word. If the term is associated with an existing baseword, then a pull down menu is used to select a respective baseword. If a new base-word is selected, then an input field will be displayed to enter the new base-word name. After the term is successfully entered, the ontology is updated. The user may enter a new file name or save it over the existing file name.

FIG. 20 illustrates a table identifying the newly entered term names and their associated base words. A submit button is selected and the new terms are inserted within the user ontology file. The user may then download the new file and execute a new mining operation based on the new ontology file.

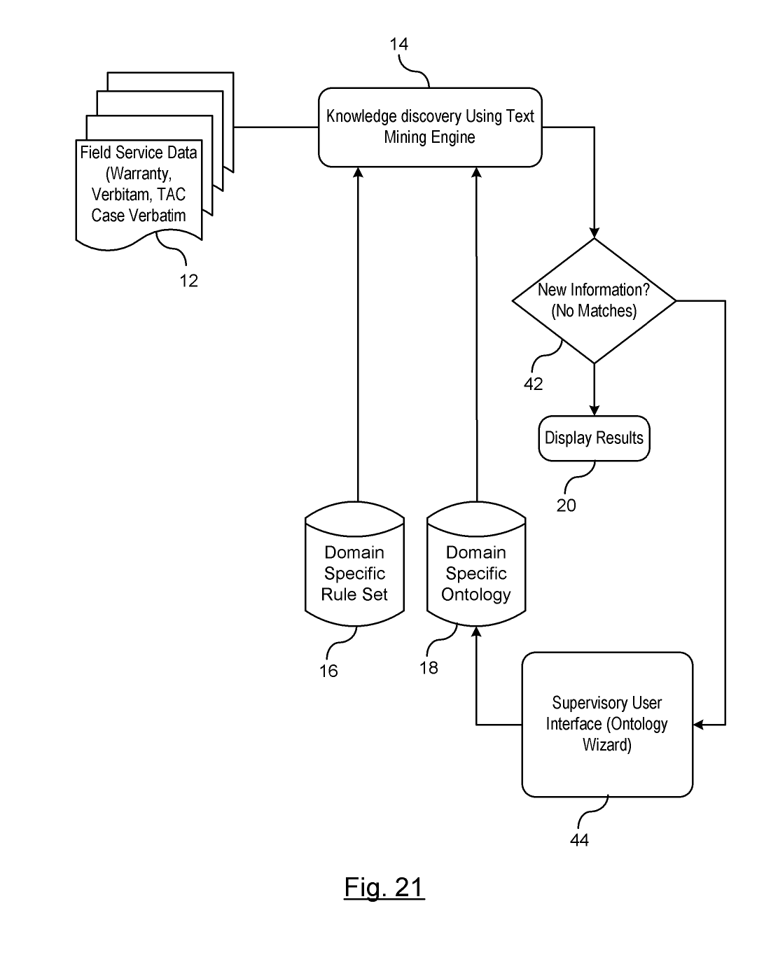

FIG. 21 illustrates a block diagram for extracting verbatims based on the domain specific rule set and the user selected ontology. The warranty database 12, as described earlier, includes various warranty data, customer verbatims, and service technician verbatims. The knowledge mining processing unit 14 extracts service verbatims from the warranty database 12 utilizing the domain specific rule set 16 and the user selected ontology 18. Rules in the domain specific rule set are configured utilizing parameter data entered by the user. Based on the specified parameters, rules are configured for extracting verbatims based on the symptom or actions. The rules for extracting data are provided from the domain specific rule set 16 to the knowledge mining processing unit 14.

In addition, user selected ontology 18 is provided to the knowledge mining processing unit 14. The user selected ontology 18 may include the ontology from the primary ontology database that is generic to all users, or may include the ontology from the local ontology database. The local ontology database as described earlier is located on a local server and is customized by the user maintaining criteria specific to the technology for which the warranty is being reviewed. The user may have stored various different files where each file is customized by the user for a respective technology.

After execution of the knowledge mining processing unit 14 for segregating the service verbatims into the various categories, a determination is made in block 42 as to whether the any non-matches are present. If non-matches are present, then a supervisory user interface engine 44 (e.g., ontology wizard), guides the user either placing non-matching service verbatims into an existing category or generates a new category. The user selected ontology 18 is then updated with the new category and the knowledge mining processing unit will re-mine the service verbatims in the warranty database 12. A determination is made whether the non-matches are reduced or eliminated. The user may continue to utilize the supervisory user interface engine 44 to further reduce the number on non-matches or evaluate the existing data with the remaining non-matches left. If the user is satisfied with the latest results from the last data mining operation, then the results are output by the report generator 20. Reports may be output that include, but are not limited to, a spreadsheet identifying various information such as the vehicle identification number, make, model, mileage, claim date, cost, and verbatim language as entered by the service personnel, customer, or other personnel. All service verbatims may be grouped and output by each respective category. Reports may also include pareto charts configured to represent user selected data.

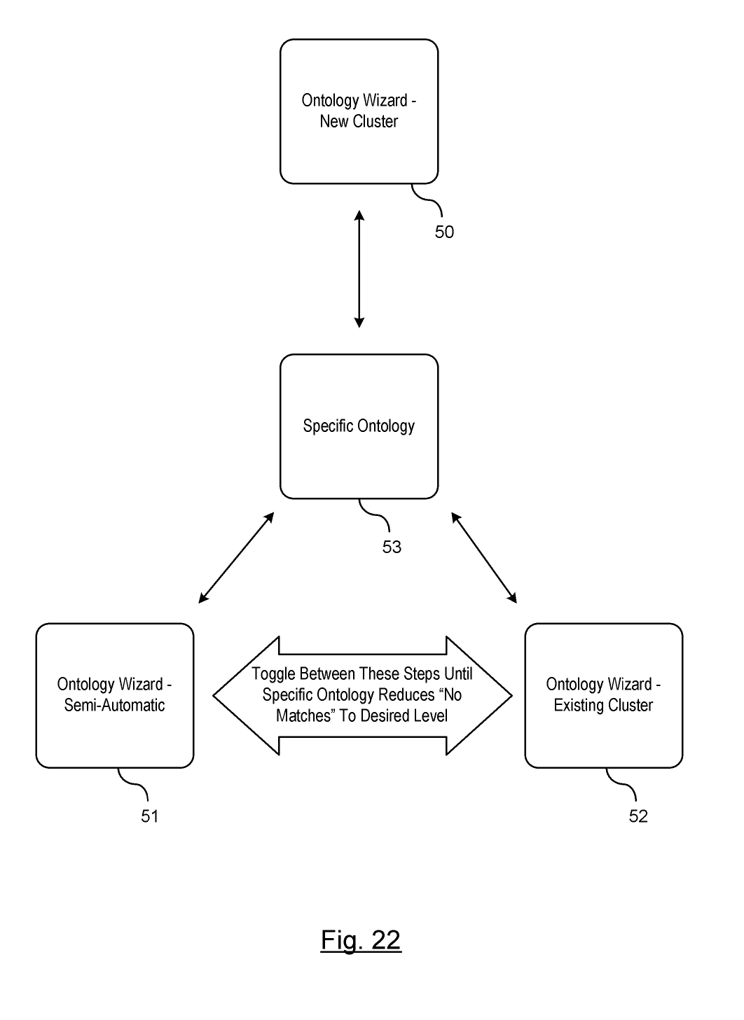

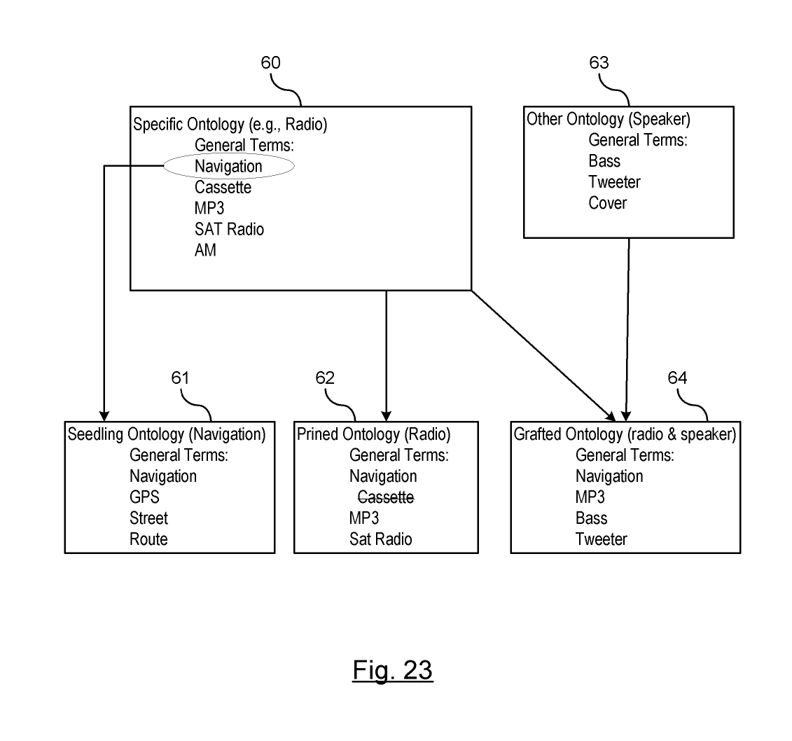

FIG. 22 illustrates a flowchart for the supervisory user interface engine. In block 50, the ontology wizard is executed by selecting a new cluster. The new cluster is provided a name that applies to the area of technology. This step may be performed autonomously by creating new cluster names and mapping text phrases based on frequently occurring like text phrases found in respective verbatims.

In block 51, text phrases in the service verbatims are mapped to the new cluster names. The ontology wizard is executed in a semi-automatic operation to create more cluster names mapped to the text phrases. This involves a user highlighting selected text. The tool compares the highlighted text to existing text phrases. The system will prompt the user for approval to map the text phrases to the new or existing cluster names.

In block 52, the ontology wizard is executed utilizing existing clusters by searching for text phrases that are similar to those found in blocks 50 and 51. Existing text phrases are compared to existing ontology for like patterns. Upon finding the matches, the user is prompted to approve the updates. The system toggles between blocks 51 and 52 reducing the number of service verbatims in the non-match category until a desired level service verbatims within the non-match category is obtained. In step 53, the ontology is updated each time a local ontology is modified.

FIG. 23 illustrates a process for modifying terms from the selected ontology subset. The process includes a grafting, pruning, and seedling technique. In block 60, the user obtains the primary ontology database or an existing local ontology database and selects a specific ontology (e.g., radio). A selection menu identifies the specific terms which can be selected from the ontology. The terms include, but are not limited to, components, subsystems, systems, technology, and features. For the radio ontology, exemplary terms include navigation, cassette, MP3, XM, AM.

In block 61, the user, if desired, may drill down to more specific terms of the selected ontology. This is referred to as the seedling ontology. For example, if Navigation is selected, general seedling terms associated with navigation may include, but are not limited to, GPS, street, and route.

In block 62, the specific technology may be selectively pruned for removing unwanted ontology from the local ontology database. This may be performed autonomously by analyzing the scan sources and determining whether any terms are no longer being found by the scan sources. In radio systems, cassettes may no longer be assembled into vehicles and as a result, the term cassette is a term that gets no matches by the system. Therefore, to avoid unwanted computing, the user or ontology wizard may remove the term cassette from the local ontology.

In step 63, a second ontology is provided for merging with the first ontology selected in step 60. The second ontology preferably has a relation to the first ontology.

In step 64, the user or ontology wizard may merge more than one ontology together. For example, if a user maintains a modified local ontology, but the primary ontology is modified with new technologies, the user may want to incorporate the added technology. Alternatively, the user may want to join an ontology (e.g., speakers) that has a relation to the selected ontology (e.g., radio). The system upon merging the two ontologies will analyze and remove duplicates in the system.

While certain embodiments of the present invention have been described in detail, those familiar with the art to which this invention relates will recognize various alternative designs and embodiments for practicing the invention as defined by the following claims.

What is claimed is:

1. A warranty detection system for service repairs of vehicles, the system comprising:
a warranty database for storing service repair verbatims, the service repair verbatims including information relating to an identified concern with the vehicle;
an ontology database that specifies relationships between service terms includes linking relationships between vehicle terminology and cluster categories, the ontology database being reconfigurable for allowing a user to add, delete, and modify contents within the ontology database;
a verbatim extraction tool for extracting service repair verbatims from the warranty database as function of user selected parameters and a user selected ontology, wherein the user selected ontology is a subset of the ontology database, wherein the service verbatims are segregated into a plurality of cluster categories as a function of the selected parameters and the user selected ontology; and
a report generating device for selectively generating reports based on segregating service verbatims into a plurality of cluster categories, the reports identifying an aggregate number of service verbatims associated with respective cluster categories, wherein each respective cluster category includes associated service repair verbatims that are selected as a function of the linking relationship of terms within the service verbatim and the user selected ontology.

2. The system of claim 1 wherein the wherein the ontology database as reconfigured by the user is a local ontology database, wherein the local ontology database is downloaded from a primary ontology database for allowing the user to revise and manage the local ontology database.

3. The system of claim 2 wherein the wherein the user selects an ontology subset from the ontology database, the ontology subset including a plurality of terms associated with a respective vehicle technology.

4. The system of claim 3 wherein the user selectively prunes terms from the selected ontology subset.

5. The method of claim 3 wherein the user merges a second ontology subset with the selected ontology subset for generating a merged ontology subset.

6. The system of claim 5 wherein duplicate terms are removed from the merged ontology subset.

7. The system of claim 1 wherein the plurality of cluster categories includes a no-match cluster category, wherein service verbatims not matching any of the clusters in the selected ontology subset are entered into the no-match cluster category.

8. The system of claim 1 further including an ontology wizard wherein a text phrase of a service verbatim in the no-match category is selected for generating a new cluster category or for mapping to an existing category.

9. The system of claim 8 wherein the ontology wizard autonomously generated the new cluster category based on frequently occurring text phrases and maps the text phrases to the new cluster category.

10. The system of claim 8 wherein the ontology wizard autonomously maps the text phrases to an existing cluster category based on frequently occurring text phrases substantially similar to existing text phrases within the existing cluster category.

11. The system of claim 8 wherein each service verbatim in the no-match cluster is analyzed for identifying text phrases substantially similar to text phrases associated with the added text phrases in the new cluster category or existing cluster category.

12. The system of claim 1 wherein the selected parameters includes labor codes.

13. A method of categorizing service verbatims in a vehicle service reporting system, the method comprising the steps of:
storing service repair verbatims in a warranty storage database that includes at least one memory storage device, the service repair verbatims including information relating to an identified concern with the vehicle;
generating an ontology database that specifies relationships between service terms that includes linking relationships between vehicle terminology and cluster categories, the ontology database being reconfigurable for allowing a user to add, delete, and modify contents within the ontology database;
extracting service repair verbatims from the warranty database as function of user selected parameters and a user selected ontology utilizing a verbatim extraction tool, wherein the user selected ontology is a subset of the ontology database, wherein the service verbatims are segregated into a plurality of cluster categories as a function of the selected parameters and the user selected ontology; and
selectively generating reports based on segregating service verbatims into a plurality of cluster categories using a report generating device, the reports identifying an aggregate number of service verbatims associated with respective cluster categories, wherein each respective cluster category includes associated service repair verbatims that are selected as a function of the linking relationship of terms within the service verbatim and the user selected ontology.

14. The system of claim 13 wherein the ontology database as reconfigured by the user is a local ontology database, wherein the local ontology database is downloadable from a primary ontology database for allowing the user to revise and manage the local ontology database.

15. The system of claim 14 wherein the wherein the user selects an ontology subset from the local ontology database, the ontology subset including a plurality of terms localized to a specific vehicle system.

16. The system of claim 16 wherein the user selectively prunes terms from the selected ontology subset, wherein pruning includes discarding unwanted ontology from the local ontology database.

17. The method of claim 16 wherein the user merges a second ontology subset with the selected ontology subset for generating a merged ontology subset, wherein one of the duplicate terms within the merged ontology subset is removed.

18. The method of claim 13 further comprising the step of creating a no-match cluster category, wherein service verbatims not matching any of the plurality of clusters in the selected ontology subset are binned to the no-match cluster category.

19. The method of claim 18 wherein a text phrase from a service verbatim in the no-match category is selected for generating a new cluster category or for mapping to an existing category.

20. The method of claim 19 wherein the new cluster category is autonomously generated based on frequently occurring text phrases, and wherein the frequently occurring text phrases are mapped to the new cluster category.

21. The method of claim 18 wherein a text phrase in the no-match category that is substantially similar to an existing test phrase in an existing cluster category is mapped existing cluster category.

22. The method of claim 13 wherein labor codes are utilized as the user selected parameters.

23. The method of claim 13 wherein the user selected parameters include domain specific parameters.

24. The method of claim 13 wherein the user selected parameters include special case parameters.
